(19) United States
(12) Patent Application Publication
(10) Pub. No.: US 2015/0276215 A1
(43) Pub. Date: Oct. 1, 2015

(54) Edible Coconut Endosperm Wick

(71) Applicant: DANILO E. MONZON, Miami, FL (US)

(72) Inventor: DANILO E. MONZON, Miami, FL (US)

(21) Appl. No.: 14/229,260

(22) Filed: Mar. 28, 2014

(51) Int. Cl. F23D 3/18; A23L 1/00; A23L 1/212

(52) U.S. Cl. CPC F23D 3/18; A23L 1/212; A23L 1/0073; A23V 2002/00

(57) ABSTRACT

A strand of coconut endosperm wick composed substantially of cellular layers of a coconut endosperm. The strand of coconut endosperm is selectively removed from an inner surface of a coconut husk and then shaped and dimensioned to form a generally linear or strand like shape. The starch, oil, and high water content of the coconut endosperm form a generally malleable composition that enables the creation of a wick. A mounting end embeds into a candle, such as a candle. A free end burns a flame to generate a smoked coconut smell. Both the strand of coconut endosperm wick and the attached candle are edible and can be used for gag gifts, celebrations, and cake decoration. The present invention only utilizes the coconut endosperm. The fiber, husk, brush, roots, or bran present of the coconut does not make up any portion of the strand of coconut endosperm wick.

### BACKGROUND

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon.

The present invention is directed to a coconut endosperm wick composed substantially of cellular layers of a coconut endosperm. The coconut endosperm wick forms a substantially linear, malleable wick that can attach to a wide variety of candles, such as a candle. The coconut endosperm wick forms an organic wick that burns to generate a smoked coconut smell. The coconut endosperm wick also forms an enhanced capillary action due to the composition of the coconut endosperm.

Typically, a wick used with a candle is comprised of a bundle or loose twist or braid of soft threads, or a woven strip or tube. Common materials may include cotton or asbestos. The wick can be used with a candle, lamp, oil stove, or cigarette lighter to help generate a flame. The wick receives fuel for the flame by burning and by drawing up the melted tallow, wax, oil, or other flammable liquid to be burned at a terminal end of the wick.

In many instances, the wick emits a foul smell while burning. The residue left over from the burn can also be toxic. This may be due to the fact that the wick is fabricated from a synthetic material. These synthetic materials not only leave an undesirable residue, but also can be expensive to fabricate, as polymers may be involved. However, even a natural composition product, such as cotton, can be expensive for fabricating a relatively inexpensive object such as a candle.

One particular use of candles involves the traditional placement of candles on a birthday cake. Normally at least one or multiple candles may be placed on a birthday cake prior to the cake being sliced and eaten. Many of these candles may range in size and shape and traditionally the number of candles are equal to the recipient's age. Many children receive their birthday cakes with birthday candles and the typical child enjoys licking icing from the cake and/or the candles that may be placed on the cake.

For the foregoing reasons, there is a coconut endosperm wick that is organically fabricated from an endosperm of a coconut, that is edible, that emits a pleasant smell, and can be used with an edible candle.

Wicks have been utilized in the past; yet none with the present delivery expediting characteristics of the present invention. See U.S. Pat. No. 8,381,432; 4,810,256; and WO93103624.

For the foregoing reasons, there is a coconut endosperm wick composed entirely of coconut endosperm.

### SUMMARY

The present invention is directed to a coconut endosperm wick that is composed substantially of cellular layers of a coconut endosperm. The coconut endosperm is selectively removed from an inner surface of a coconut husk and then shaped and dimensioned to form a generally linear or strand like shape. The starch, oil, and high water content of the coconut endosperm forms a generally malleable composition that enables the creation of eclectic shapes and forms of a wick. It is significant to note that the present invention only utilizes the endosperm, or meat portion of the coconut. The fiber, husk, brush, roots, or bran present of the coconut does not make up any portion of the coconut endosperm wick.

In some embodiments, the coconut endosperm is shaped to form a bundle or loose twist of soft threads. However, other shapes may include a woven strip or tube. The generally linear, flexible shape can function as a typical wick. The wick of the present invention is edible. The coconut endosperm wick includes a free end for burning, and a mounting end for joining with a candle. The candle may be edible.

In some embodiments, the mounting end may embed inside a candle that is edible and has a pleasant smell. However, the mounting end may also join with various other candles, including, without limitation, wax candle, a lamp, a cigarette lighter, and the like. In some embodiments, the coconut endosperm wick is effective in burning to form a flame. The high oil and starch composition of the coconut endosperm wick is effective in enabling the free end to burn.

One objective of the present invention is to utilize the endosperm of a coconut for producing a coconut endosperm wick. However, only the coconut endosperm may be utilized for fabrication of the coconut endosperm wick. The present invention is not comprised of any portion of the fiber, husk, brush, roots, or bran of the coconut.

Another objective is to provide an edible wick that maintains a flame and melts.

Another objective is to produce an organic wick having no synthetic materials.

Yet another objective is to generate a smoked coconut essence while burning the coconut endosperm wick.

Yet another objective is to join the coconut endosperm wick with an edible candle for gag gifts, celebrations, and cake decoration.

### DRAWINGS

These and other features, aspects, and advantages of the present invention will become better understood with regard to the following description, appended claims, and drawings where:

FIG. 1 is a sectioned perspective view of an exemplary coconut;

FIG. 2 is a detailed perspective view of an exemplary strand of a coconut endosperm wick;

FIG. 3 is a detailed perspective view of an exemplary coconut endosperm wick shaped in a flat weave configuration; and

FIG. 4 is a flowchart showing the steps in an exemplary method for forming a coconut endosperm wick.

### DESCRIPTION

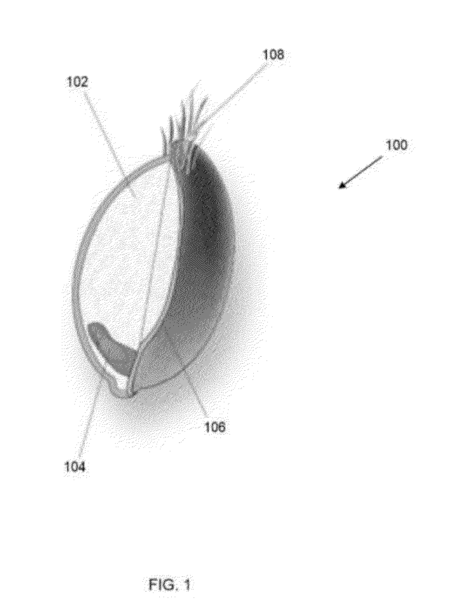

One embodiment of a strand of coconut endosperm wick 200 is illustrated in FIGS. 1-4. The strand of coconut endosperm wick 200 is an end product of a coconut 100. A strand of coconut endosperm 102 is configured to form an edible wick that burns also; thereby creating the present invention. The strand of coconut endosperm wick 200 is not configured from any other portion of the coconut 100. For example, the fiber 108, bran 106, germ 104, husk, brush, or roots present in the coconut 100 do not make up any portion of the strand of coconut endosperm wick 200. The strand of coconut endosperm wick 200 can join with a candle 208, often an edible type of candle 208. In this manner, the strand of coconut endosperm wick 200 and the candle 208 may be used in various celebratory activities, including, without limitation, gag gifts, celebrations, and cake decoration. In one embodiment, the strand of coconut endosperm wick 200 and the candle 208 could then be eaten with the cake thereafter.

FIG. 1 shows a coconut 100, from which the present invention is comprised. The coconut 100 chiefly grows in a tropical or subtropical region and provides numerous uses, such as food, construction material, and fiber material objects. The coconut 100 comprises a bran 106, which covers a hard exterior shell of the coconut 100. The coconut 100 originates from a seed that forms a germ 104. The germ 104 can form a germ shell that has three germination pores that are clearly visible on the outer surface area of the coconut 100 once the bran 106 is removed. A fiber 108 out grows from the bran. The fiber 108 may be used to fabricate ropes, mats, and fasteners. The coconut 100 has a fibrous root system.

A coconut endosperm 102 is the portion of the coconut 100 that is the white, inner meat. The coconut endosperm 102 grows on an inner surface of a coconut shell, increasing in thickness and density as the coconut 100 matures. Accessing the coconut endosperm 102 requires forcibly breaking or cutting the coconut 100. The coconut endosperm 102 comprises a high proportion of water, starch, and oil. The starch, oil, and high water content of the coconut endosperm 102 forms a generally malleable composition that enables the creation of eclectic shapes and forms. In some embodiments, the coconut endosperm 102 can be removed from the coconut 100 and shaped to form a generally linear or strand like shape.

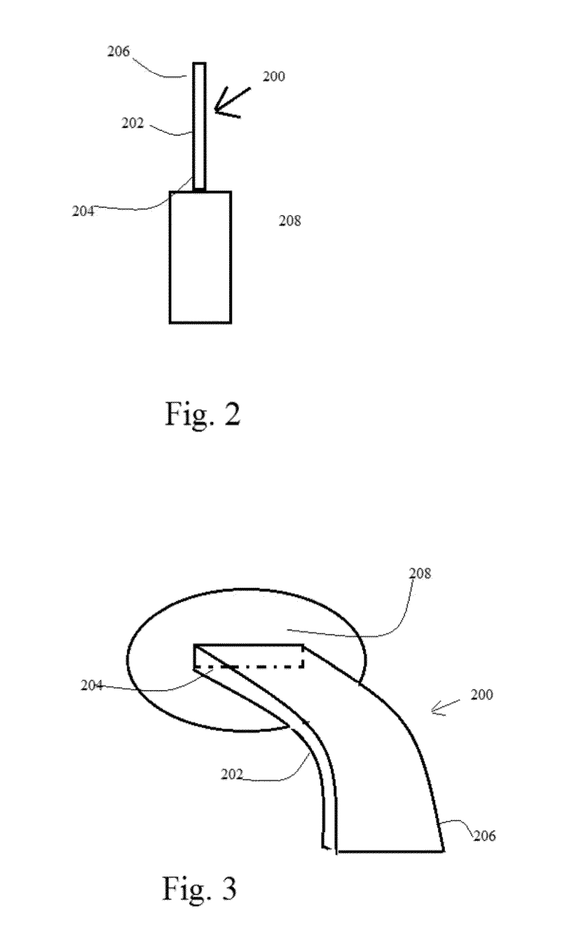

Turning now to FIGS. 2 and 3, the coconut endosperm 102 is shaped and dimensioned to form a strand generally wick shaped configuration. In some embodiments, the strand of coconut endosperm wick 200 may form a bundle or loose twist of soft threads. FIG. 2 illustrates a thin strand that embeds into a standard candle known in the art. FIG. 3 illustrates a flat, woven strip configuration for the coconut endosperm wick 200. However, other shapes for the strand of coconut endosperm wick 200 may include, without limitation, a thick cord, a plane, a tube, and a conical or annular cross section. However in some embodiments, the generally linear, flexible shapes formed by the strand of coconut endosperm 102 is effective for functioning as a coconut endosperm wick 200. In some embodiments, the coconut endosperm wick 200 may be dyed into various colors for decorative effects.

In some embodiments, the strand of coconut endosperm wick 200 includes a free end 206 and a mounting end 204. The free end 206 generally orients above the mounting end 204. A longitudinal axis 202 extends between the ends 204, 206. The mounting end 204 embeds into a candle 208. In this manner, the mounting end 204 provides a foundation for the strand of coconut endosperm wick 200, and the free end 206 can ignite into a flame. The flame, in following the characteristics of the coconut endosperm 102, generates a smoky coconut smell. In one embodiment, candle 208 that joins with the strand of coconut endosperm wick 200 may include an edible candle having a variety of tastes and smells.

In some embodiments, both the strand of coconut endosperm wick 200 and the candle 208 can be eaten before or after the flame is lighted. The edible nature of the coconut endosperm 102 makes the strand of coconut endosperm wick 200 edible. The candle 208 may or may not be edible. However, an edible candle enables full consumption of the joined strand of coconut endosperm wick 200 and the candle 208. In any case, the strand of coconut endosperm wick 200 and the candle 208 can be used for gag gifts, celebrations, and cake decorations. However, any other use that is normally applied to an edible wick and edible candle may be utilized for the present invention.

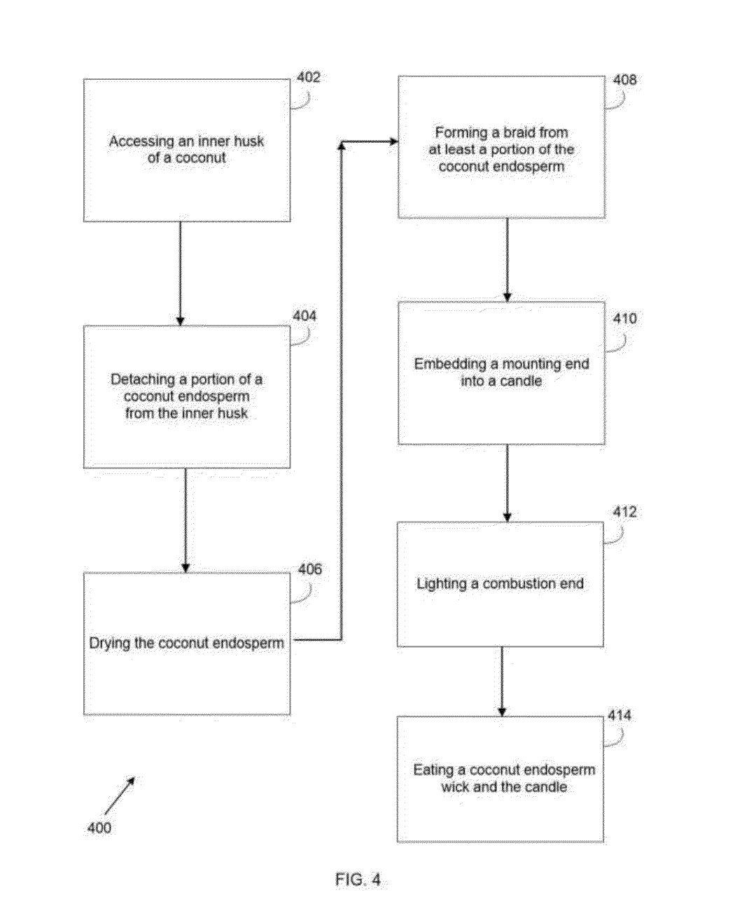

FIG. 4 shows a method 400 for forming a strand of coconut endosperm wick 200. The method 400 includes an initial Step 402 of accessing an inner husk of a coconut 100. Those skilled in the art will recognize that the coconut 100 requires forcible breakage to access the inner meat, which forms the coconut endosperm 102. It is important to note that no other portion of the coconut 100 combines with the coconut endosperm 102 in fabrication of the coconut endosperm wick 200. A further Step 404 may include detaching a portion of a coconut endosperm 102 from the inner husk. The coconut endosperm 102 may be sliced with a razor to form small linear strands sized and dimensioned to form a wick. However, any form or shape may be used to form the strand of coconut endosperm wick 200.

The method 400 further includes a Step 406 of drying the coconut endosperm 102. The coconut endosperm 102 may be dried by heating in an oven for an hour at over two hundred degrees Fahrenheit. However in other embodiments, the coconut endosperm 102 may be sun dried. The high water content of the coconut endosperm 102 requires drying to enable the functional aspects of the coconut endosperm wick 200.

A Step 408 comprises forming a braid from at least a portion of the coconut endosperm 102. The detached portions of the coconut endosperm 102 can be intertwined to form a braid, or other flexible linear member effective for forming a wick. In some embodiments, a Step 410 may include embedding a mounting end 204 into a candle 208, such as a candle. In this manner, the mounting end 204 provides a foundation for the strand of coconut endosperm wick 200, and also enables access the candle 208 such that the free end 206 can ignite into a flame.

A Step 412 includes lighting a free end 206 of the strand of coconut endosperm wick 200. Upon lighting a flame can form. The flame is fed from the strand of coconut endosperm wick 200 itself, and the fuel that travels towards the free end 206. A final Step 414 comprises eating the strand of coconut endosperm wick 200 and the candle 208. The edible nature of the coconut endosperm 102 makes the wick edible. The candle 208 may or may not be edible. In any case, the strand of coconut endosperm wick 200 and the candle 208 can be used for gag gifts, celebrations, and cake decorations.

While the inventor's above description contains many specificities, these should not be construed as limitations on the scope, but rather as an exemplification of several preferred embodiments thereof. Many other variations are possible. For example, the strand of coconut endosperm wick 200 could be utilized for aromatherapy candles due to the smoked coconut smell emitted while burning. Accordingly, the scope should be determined not by the embodiments illustrated, but by the appended claims and their legal equivalents.

What is claimed is:

1. A wick, the wick comprising:
a strand of coconut endosperm, the strand coconut endosperm is derived from a coconut and is free from any portion of a fiber, a husk, a brush, a root, or a bran present in the coconut, the strand of coconut endosperm defines a mounting end configured to join with a candle, a free end configured to generate a flame, and a longitudinal axis.

2. The wick of claim 1, in which the strand of coconut endosperm is attached to an edible candle.

3. The wick of claim 2, in which the flame emits a smoked coconut smell.

4. A method for forming a strand of coconut endosperm wick, the method comprising:
accessing an inner husk of a coconut;
detaching a portion of a coconut endosperm from the inner husk;
drying the coconut endosperm;
forming a braid from at least a portion of the coconut endosperm;
embedding a mounting end into a candle;
lighting a free end; and
eating the strand of coconut endosperm wick and the candle.

5. The method of claim 4, in which detaching a portion of a coconut endosperm further comprises slicing a strand of the coconut endosperm at least two inches long from an interior husk of the coconut.

6. The method of claim 5, in which drying the coconut endosperm comprises heating in an oven for an hour at over two hundred degrees Fahrenheit.

7. The method of claim 6, in which the braid comprises a wick.

8. The method of claim 7, in which the candle is edible.

9. The method of claim 8, in which the strand of coconut endosperm wick is edible.
